(19) United States
(12) Patent Application Publication
(10) Pub. No.: US 2017/0007058 A1
(43) Pub. Date: Jan. 12, 2017

(54) Delivery Methods and Receptacle Apparatus Delivery Receptacle Enclosure

(71) Applicant: Joshua Aaron Nuckols, Huntsville, AL (US)

(72) Inventor: Joshua Aaron Nuckols, Huntsville, AL (US)

(21) Appl. No.: 15/017,628

(22) Filed: Feb. 6, 2016

Related U.S. Application Data
(60) Provisional application No. 62/188,764, filed on Jul. 6, 2015.

(51) Int. Cl. A47G 29/124; A47G 29/126; B65G 47/26; A47G 29/12

(52) U.S. Cl. CPC A47G 29/124; A47G 29/12; A47G 29/126; B65G 47/26

(57) ABSTRACT

Provided are methods and devices for the delivery of material goods incorporating automatable components. An automated delivery method when implemented with the appropriate delivery receptacle allows for greater efficiency and convenience through automation. An order for consumer goods placed over the Internet can be properly packaged and connected with a delivery vehicle that may be fully automated. The delivery vehicle will transport the material item(s) to a receptacle enclosure at a delivery destination; which may be located near the buyer's residence or workplace. The receptacle enclosure may be configured to receive the material items directly from the vehicle. Whereby material items may be transported and received with less labor at any time of any day.

### CROSS-REFERENCE TO RELATED APPLICATION

The present utility patent application is related to and claims priority benefit of the U.S. provisional application No. 62/188,764, filed on Jul. 6, 2015 under 35 U.S.C. 119(e).

### BACKGROUND

Conventional methods for transporting material goods, especially goods ordered over the Internet, have some benefits. Conventionally, an order for goods is routed to a warehouse nearest the delivery destination. At the warehouse the seller packages the ordered items. The seller then relies on a third-party carrier to deliver the package to the delivery destination. The carrier uses a human vehicle operator, the same of which must hand unload the delivery items at the destination and walk them to a place suitable for them to remain until the buyer receives them. In a suburban or rural environment hand carrying deliveries to the front of a dwelling is a very labor intensive task. Leaving deliveries on the road side exposes them to undue theft and weather perils. Some consumers use manual delivery enclosures to secure delivery items.

Conventional enclosures for delivery items have a means of accepting deliveries from human personnel, but do not accept items directly from automated delivery vehicles. Conventional enclosures may have a secure and weatherproof means for receiving and storing delivery items, but do not allow for temperature and humidity control of perishable items.

Conventionally, a consumer has limited choice for acquiring perishable goods by proxy. Perishable items such as food and medicines must be transported in a timely manner and must be manually received and temperature maintained. Present solutions for perishability are both labor reliant and packaging intensive.

### SUMMARY

This summary is provided to introduce some of the related concepts in a simplified form that are further described below in the Detailed Description.

The present disclosed apparatus and method seeks to provide a solution to these problems by providing a storage enclosure that features automated package reception. The receptacle enclosure may be situated near a drivable surface; a landing surface, if the delivery vehicle is capable of aerial transport. The preferable configuration consists of a weatherproof and securable outer housing, opening and/or chute, proximity sensor/transponder, temperature controllable storage compartment(s), wireless communication hardware, a control circuit, electronic power source. A mobility means may also be included that allows for automatic or manual position-ability, and an interface for item retrieval by the consumer.

When implemented, the present invention will help reduce road traffic and reduce the consumer's time-costs involved in goods procurement. Additionally, automated methods may reduce packaging requirements and create a channel for reuse of packaging containers. The apparatus and methods herein outlined, may also help reduce the overall energy and resource inputs of the consumption cycle. In the long term, the present invention may work to reduce the need for regular merchandise stores; this consolidation effect will create ancillary energy savings to those savings already mentioned. Alternately, the existing stores may be partially converted to function as warehouses servicing automated delivery vehicles that are a part of this overall system.

On a regular basis delivery vehicles may make routine and/or expedited delivery routes to the consumer's home to deposit delivery items into a receptacle enclosure. The routine delivery route may be conducted any hours of the day or night.

Upon the arrival of a delivery truck, a proximity sensor may allow access to a storage compartment inside the enclosure. The opening may pivot outward to receive a delivery item from either a delivery person or a conveyance attached to a delivery vehicle. The package then progresses into the storage compartment(s) where it can be securely stored until consumer retrieval. The delivery item(s) may be identified by a sensor connected to a control circuit for: contents, source, and temperature requirements. Data of the package contents and a notice of arrival can be wirelessly transmitted to the user's email/wireless device or other notification means.

In a premier embodiment the enclosure may feature equipment to self transport automatically or manually between 2 points at the destination location: Point A, a docking station inside or near the structure, and Point B, a delivery location near a drivable surface. The consumer may recall the enclosure to return to Point A after receiving the delivery. Alternately the enclosure may automatically be programmed to return to Point A after receiving the delivery. The consumer may then access delivery items more conveniently.

### BRIEF DESCRIPTION OF DRAWINGS

Embodiments are illustrated by way of example and not limitation in the Figures of the accompanying drawings; like references indicate similar elements; in which:

FIG. 1A illustrates an example configuration and example location of a receptacle enclosure.

FIG. 1B illustrates an example receptacle enclosure chute.

FIG. 2 illustrates an overview of the delivery environment where the apparatus and methods may be implemented.

FIG. 3 illustrates a delivery interaction including both method and apparatus.

FIG. 4 illustrates a receptacle that is configured to position by itself.

FIG. 5 illustrates a parked car that is configured as a receptacle enclosure.

* A list of reference numerals is included at the end of the written description.

### DETAILED DESCRIPTION

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

Using method concepts herein detailed, buyers and sellers may interact in a more convenient, cost/time efficient manner. Reducing costs associated with delivery of material goods can reduce the overall price of acquiring goods. Reducing the amount of time involved with the procurement of consumer goods permits the buyer to reduce their individual time-cost inputs.

In this delivery model consumers may make purchase decisions and dictation from any location within the limits of communications networks. At any time of the day, a buyer may use a network-enabled electronic device (e.g. mobile phone, tablet, computer, or push button) to make consumer goods decisions for themselves, their households, or businesses. An order may be placed and delivery may be set for a time and location that best fits the needs of the consumer.

Upon receiving the order transmission, the seller, may process the payment and route the order to a warehousing facility nearest to the delivery destination. For the sake of this present disclosure “Location X” is the general starting location for item(s) to be delivered. “Location Y” is the delivery destination where there is a receptacle enclosure.

The seller may process the order specifications at the warehouse, location X. This may comprise the steps of gathering, shielding, and enclosing the items in one or more containers with packing materials. The container may be reusable. The container may be configured with a microchip or similar hardware that allows data storage and transmittal. Such data might be concerning the contents, destination, and location. Such a microchip may allow geographic location awareness. Such a microchip may also provide the benefit of deterring theft or tampering. The location awareness hardware may be configured to allow real-time precise tracking of deliveries. Once the items are packed and finalized they may be queued for physical connection with a delivery vehicle. The vehicle may be able to operate on road ways without human oversight. Although in some embodiments the vehicle may be operated by a human and the delivery items exit the vehicle via a mechanical means.

The vehicle may be able to accommodate many tons of weight and volume of many cubic meters. The vehicle may only carry one delivery to one destination in an expedited fashion. The vehicle may carry many deliveries to many destinations. The vehicle may have many openings for item entrance and exit. The vehicle may have opening(s) on each side for item discharge. The vehicle opening(s) may also have a conveyance apparatus that permits the automatic discharge of orders to the receptacle enclosure. The conveyance may be complete and fully extend to the receptacle opening. The conveyance may extend to a separate conveyance that extends from the roadside receptacle.

Many embodiments of this overall delivery system will need to accommodate safe transport and holding of perishable items. Perishable items such as food and medicine may be packed in insulating containers. Additionally, they may be packed with a heat absorbing or releasing mass item. In an alternate embodiment the delivery items may be packed in a container with an active temperature control means such as thermoelectric cooling. The delivery vehicle may have a means of temperature control in the cargo hold.

Upon arrival at the delivery destination the delivery vehicle may unload the perishable delivery items to a receptacle enclosure which may be configured with a self contained temperature control means. There may be separate compartments that maintain separate temperatures. The delivery items will be held inside of the enclosure until retrieval which may be many hours later.

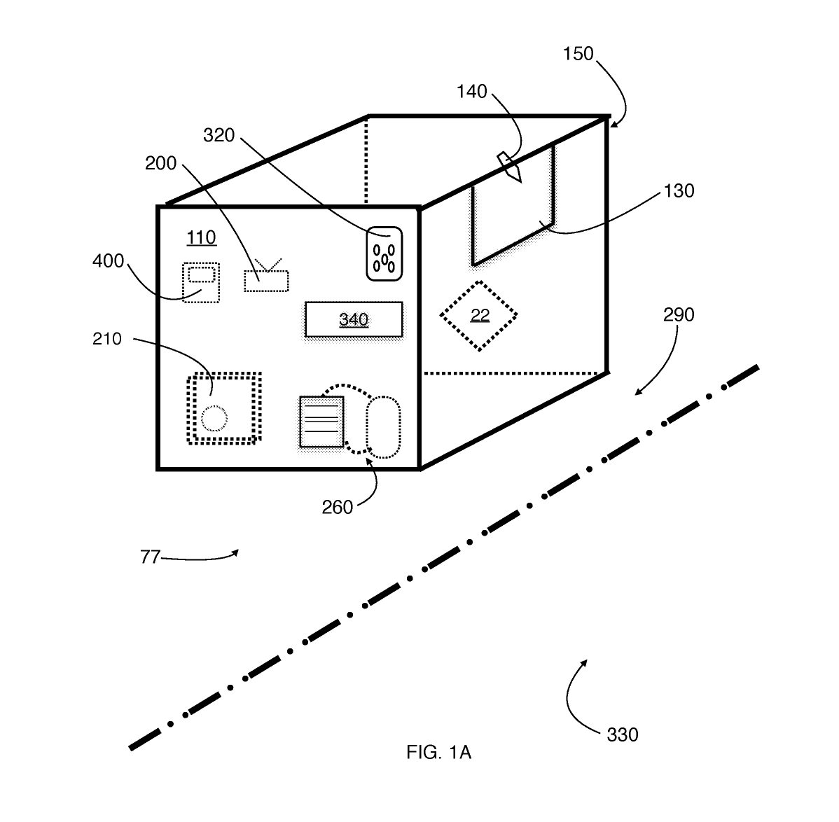

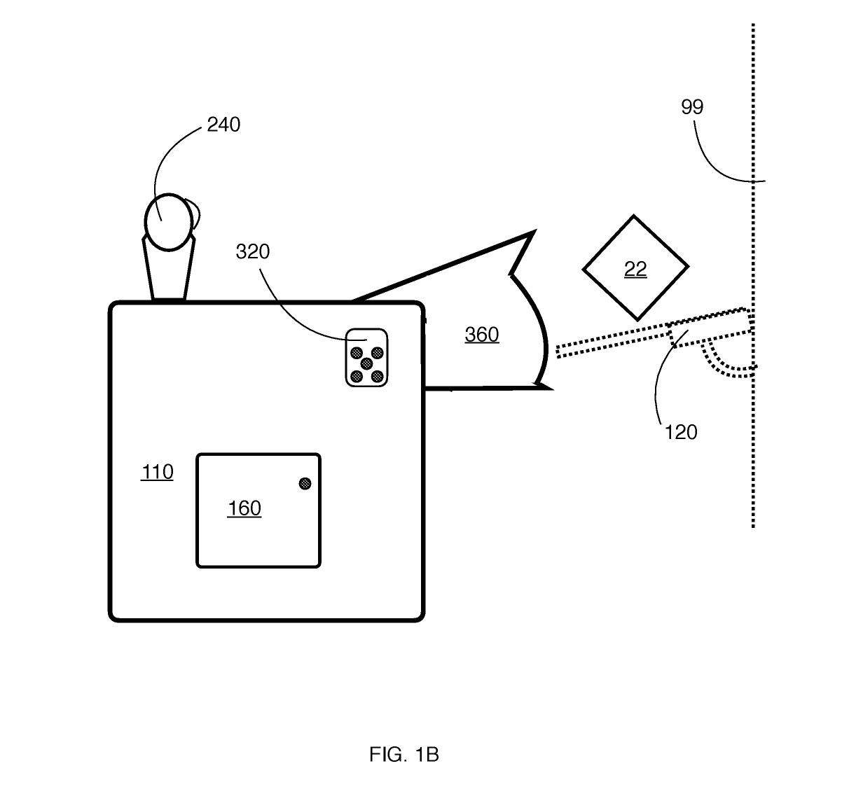

Referring now to the drawings, FIG. 1A illustrates a location Y 77 with a receptacle enclosure 110 which has an outer housing 150, an opening 130, that pivots in this embodiment. The opening has a securable latch 140. There is a delivery item 22 which has been delivered and awaits consumer retrieval. A temperature control means 260 is illustrated along with an electronic keypad interface 320 and a wireless data communication hardware 200. Wireless means 200 is for communication of the consumer with the receptacle, delivery carrier, and the sender of the delivery items. A control circuit 400 is illustrated. An electronic power source 210 which may be a battery and/or wired to an external electric circuit. Receptacle 110 is situated within range 290 of a delivery vehicle near a drivable surface 330.

Housing 150 is for keeping enclosure 110 and contents safe from weather and security perils. Housing 150 may include insulation to reduce heat transfer. Preferably enclosure 110 will include at least one separate compartment with heating and/or cooling configuration 260 that allows for a steady and separate temperature to be maintained. Enclosure 110 may include no separate internal compartments or multiple internal compartments, each with the ability to be maintained at a different temperature and/or humidity conditions. Compartment heating may be accomplished with a simple radiant heating coil. Compartment cooling may be accomplished with a compressor refrigeration system. More economical cooling may be accomplished with thermoelectric cooling. Thermostatic controls and gauges may be implemented and attached to control circuit 400.

Housing 150 will have at least one securable opening 130. The opening may have a conveyance means as part of the enclosure. This may simply be a hatch that pivots outward in the direction of the delivery vehicle. The opening with conveyance may be elaborate and retractable or static, such as the example of a chute. The securable opening that is retractable may be electrically powered or non-powered, balancing the weight of the door with springs or counter weights. Housing 150 may have a retrieval opening 160 for the user to unlock with a keypad 320 and gain access to item 22.

The receptacle may receive delivery items and containers of varied size, weight, and shape. Items 22 may be packed inside customize-able and proprietary crate apparatus as a substitute for conventional disposable packaging. Receptacle 110 may include a postmaster approved opening and compartment 340 solely for the regulated use of an official Postal Service. The receptacle may include separate opening(s) to receive items from private users, such as persons associated with the owner of the enclosure. These private users may use the enclosure to hand deliver items directly to the enclosure.

FIG. 1B illustrates an example design of a chute opening 360. Chute 360 demonstrates an alternate method of bridging the gap between delivery vehicle 99 and receptacle enclosure 110. Chute 360 may be fixed or pivot-able. Chute 360 may be retractable. The chute may serve to receive deliveries and/or send deliveries via a manual or automated means. Also depicted on the top of the housing is a video monitor 240. The video monitor is for the purpose of documenting all interactions with the enclosure 110. The video monitor may be used to deter tampering.

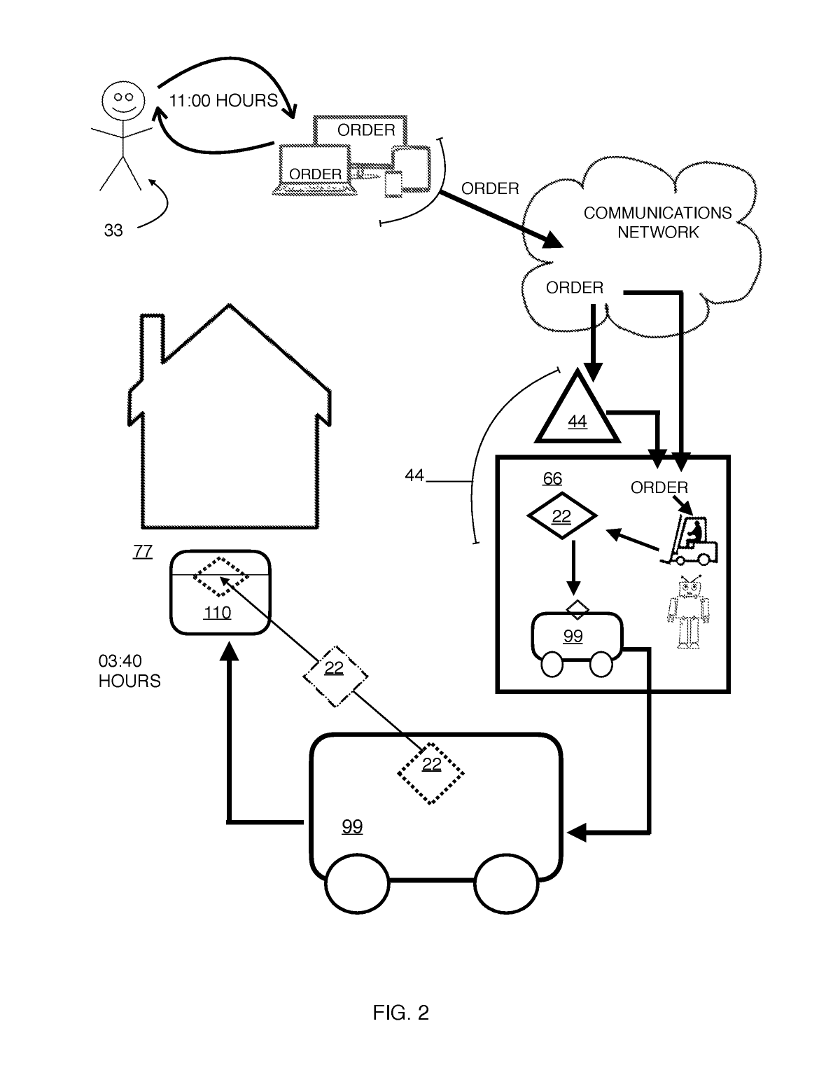

FIG. 2 illustrates the overall delivery environment where the apparatus and methods may be implemented. A buyer 33 places an order with an electronic device that is transmitted to a seller 44 via a communications network. The order is fulfilled at a warehouse 66 or location X. After being properly packaged for transport a delivery item 22 is connected to a delivery vehicle 99. Vehicle 99 transports item 22 to a destination location Y 77 with a receptacle 110. Item 22 is automatically unloaded from vehicle 99 into receptacle 110. An order placement time of 11:00 hours AM and a delivery time of 03:40 hours AM the next morning are depicted to show the time flexibility that is possible with the apparatus and method.

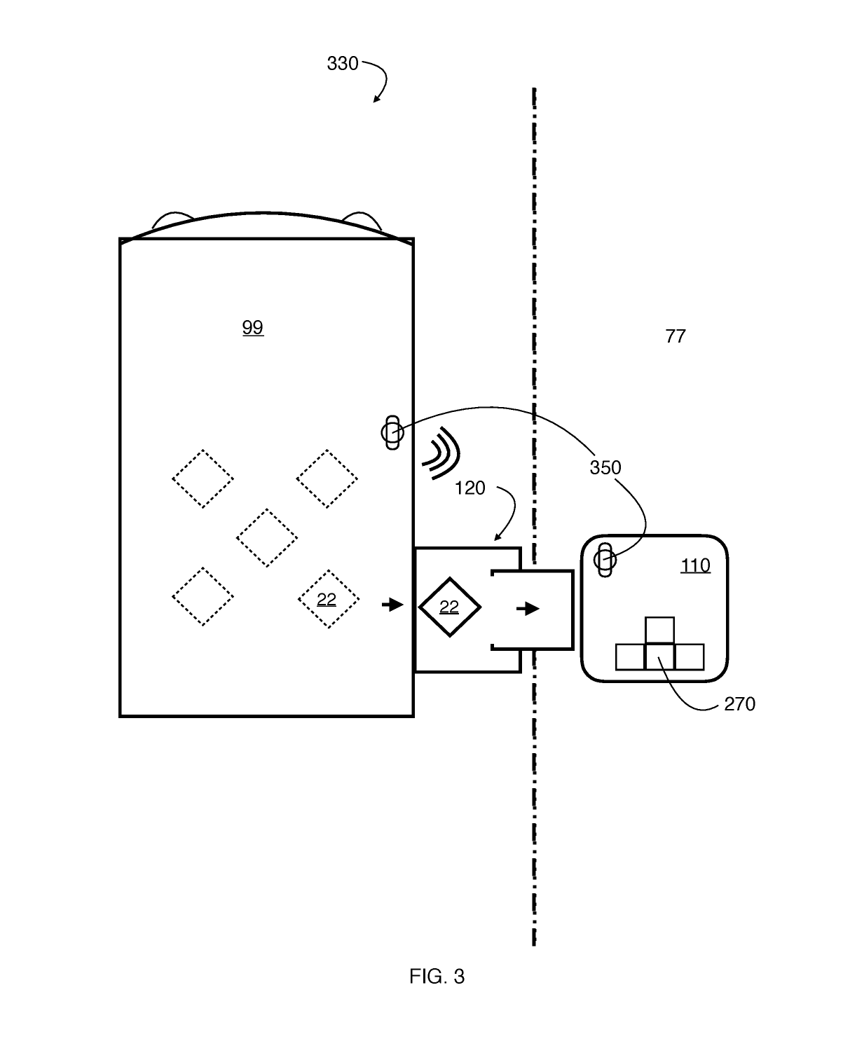

FIG. 3 illustrates an example delivery interaction at destination 77. Depicted is a receptacle 110 positioned near a roadway 330. A vehicle 99 has transported item 22 from a separate location to location 77. Vehicle 99 is paused within range 290 of enclosure 110. A retractable conveyance 120 is extended with delivery item 22 in transit from the cargo compartment to enclosure 110. Illustrated is a solar electric configuration 270 which comprises a solar cell collector wired to a battery and inverter. Vehicle 99 may drive next to receptacle 110 that is prepositioned next to the road and stop to unload delivery items. Enclosure 110 may sense the arrival of vehicle 99 through a proximity sensor 350 and a control circuit may initiate a reception command to unlatch/open and prepare to receive items. Item 22 may exit the vehicle passing out of the cargo hold of the vehicle via a retractable conveyance 120 onto the receiving hardware of enclosure 110. Item 22 will pass into the inside of the enclosure 110 and may be identified by a scanning interface. The scanning interface will send data obtained from the initial scan to a control circuit. The control circuit may identify the shipment and analyze the requirements of item 22 and correctly route them into the appropriate temperature compartment(s) or hold them in a main compartment.

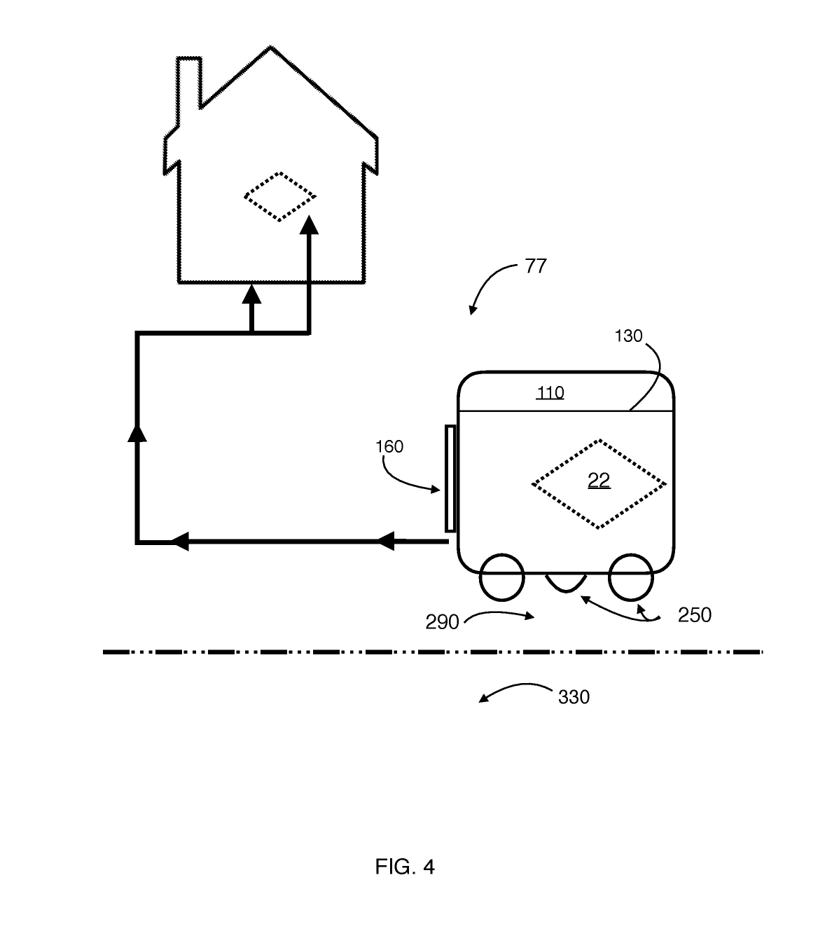

FIG. 4 overall depicts a location Y 77, where an enclosure 110 is positioned via built in wheels 250 to a suitable location 290. Illustrated on the side of enclosure 110 is a separate retrieval opening 160. A drivable surface 330 is depicted below a dashed line. Enclosure 110 is repositioned after delivery deposit to a location near or inside a structure. In this embodiment an opening 130 is illustrated as a hinged lid. A control circuit 400 may serve several functions. One function may be harmonizing and controlling all of enclosure functions. Another purpose of control circuit 400 may be processing data from the sensing hardware. The control circuit 400 may serve as the main data processor, data analyzer, and command originator of the enclosure 110. The keypad 320 connected to the retrieval opening 160 is for the purpose of allowing entry and access to the contents by the consumer. A consumer may use a code entered into keypad 320 to unlock and open the device. Alternately a consumer may use a metal key to unlock the opening 160. The receptacle may be equipped with a means and software protocol to automatically eject item 22 at a designated spot.

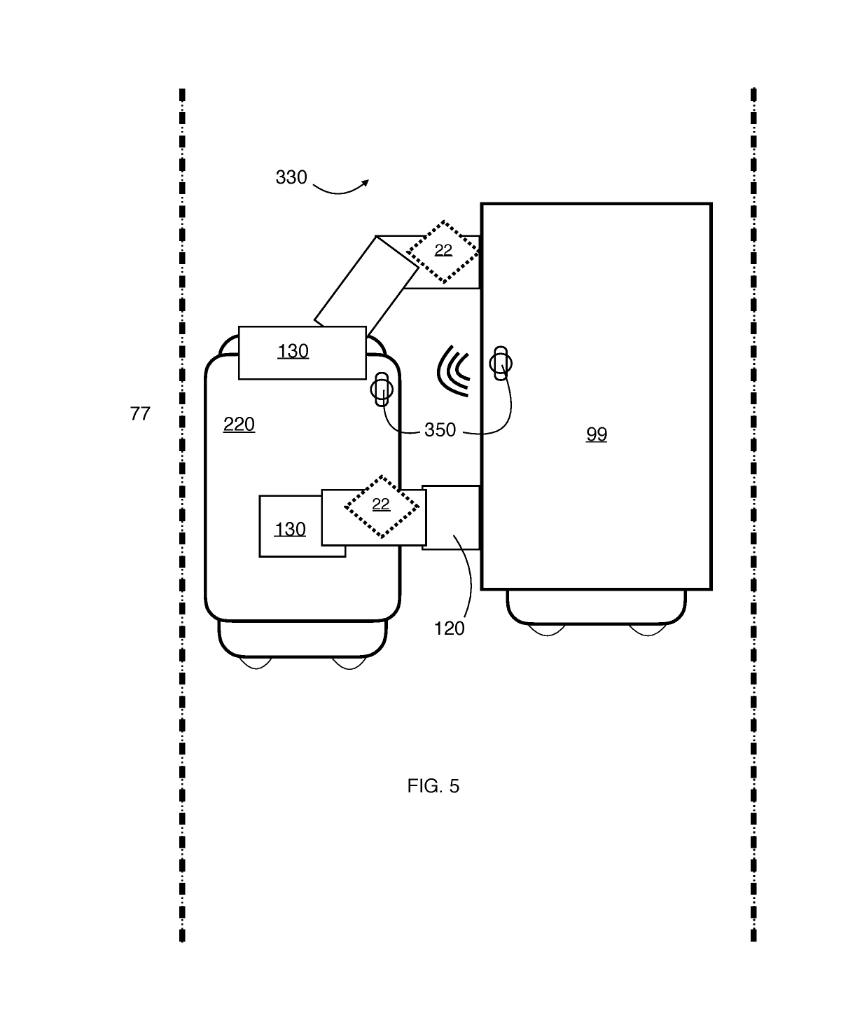

FIG. 5 depicts a parked motor vehicle 220 that functions as a receptacle wherein a roof opening or rear compartment are configured to allow access by delivery vehicle 99. The delivery vehicle 99 and the motor vehicle 220 have a proximity transmitter and receiver 350. The proximity hardware 350 will allow auto unlatch and open the secured opening(s) 130 of the motor vehicle 220. After deposit, opening 130 will be automatically closed to hold delivery item 22 until reception by the consumer. A delivery vehicle that is capable of aerial flight may land on or hover over the motor vehicle to deposit the delivery item in the opening. The motor vehicle may be configured to temperature maintain the delivery item. The motor vehicle may be automated and be able to transport the delivery item to another location at the command of the consumer.

The present disclosure continues wherein alternate features of the apparatus and method will now be described in greater detail without reference to the Figures.

Some or all openings may be securable. Some or all openings may be key accessible. A securable opening may include an electronic code receiver or biometric scanner interface. The biometric interface may scan and analyze data from, but is not limited to, the following data source: voice, eye features, fingerprint, hand features, facial features etc. or any combination. The securable interface may utilize proximity sensing technology. The securable interface may utilize remote lock/unlock technologies.

If there are a plurality of storage compartment(s) within the receptacle enclosure they may maintain contents at customize-able and separate temperatures. Delivery items may enter into appropriate compartment(s) via a complex internal mechanism or directly via a separate opening(s) or slot in the outer housing.

The electronic power source includes any wiring and charging hardware that is necessary for the electricity to be properly routed, stored, and utilized. The electronic power source may consist of a battery with charging means. The electronic power source may include solar electric technologies. The electronic power source may be a permanent connection to the home's power circuit. The electronic power source may use magnetic resonance wireless electric technology. A docking station is for the purpose of having a location nearer or inside a structure for more convenient access to delivery items. The docking station is also for the purpose of allowing the battery to recharge.

The disclosed embodiments are illustrative, not restrictive. While specific configurations of the apparatus and methods have been described, it is understood that the present invention can be applied to a wide variety of delivery and transport systems. There are many alternative ways of implementing the invention.

### REFERENCE NUMERALS

22 Delivery Item(s)
33 Buyer
44 Seller
66 Location x
77 Location y
99 Delivery Vehicle
110 Receptacle Enclosure apparatus
120 Conveyance from vehicle
130 Opening
140 Securable Latch
150 Outer Housing
160 Retrieval opening
200 Wireless data
210 Power storage/source
220 Parked car
240 Video monitor
250 Wheels for positioning
260 Temperature control
270 Solar configuration
290 Location within range
320 Keypad
330 Drivable surface
340 Mail slot
350 Proximity transponder/receiver
360 Chute
400 Control circuit

What is claimed is:

1. A receptacle enclosure apparatus for delivery items that comprises:
an outer housing wherein there is at least one opening;
wherein at least one opening is configured to permit delivery items moving inside of the enclosure without manual contact;
whereby material items may be transported to a delivery destination and received in a less labor intensive manner at any hour of any day.

2. The apparatus of claim 1, further including a means for storing or receiving electric power that is connected to an electric control circuit.

3. The apparatus of claim 1, further including a means for converting solar energy to electric power that is connected to an electrical energy storage device.

4. The apparatus of claim 1, further including a wireless data communication unit.

5. The apparatus of claim 1, wherein at least one opening is securable.

6. The apparatus of claim 1, wherein an opening is configured to permit deposit of delivery items and deter unauthorized retrieval of delivery items.

7. The apparatus of claim 1, further including a video or image recorder.

8. The apparatus of claim 1, wherein an opening is able to receive items from both manual and automated means.

9. The apparatus of claim 1, further including an opening for item retrieval.

10. The apparatus of claim 1, further including an opening that is approved for postal service use.

11. The apparatus of claim 1, further including at least one wheel to position the apparatus to a location within range of a delivery vehicle.

12. The apparatus of claim 1, further including a motor drive and an automated means to position before or after delivery items are received.

13. The apparatus of claim 1, further including an internal means for temperature control of delivery items that is connected to a thermostat or temperature sensor.

14. The apparatus of claim 1, further including a conveyor to aid in delivery item movement.

15. A method of delivering material items to a location with a receptacle enclosure apparatus comprising:
transporting a material item or items to a destination location via a delivery vehicle; the destination location having at least one receptacle enclosure apparatus within range of said delivery vehicle;
said receptacle enclosure apparatus comprising:
an outer housing wherein there is at least one opening;
wherein at least one opening is configured to permit delivery items moving inside of the enclosure without manual contact;
unloading the material item from said delivery vehicle to said receptacle enclosure apparatus without manual contact.

16. The method of delivery of claim 15, wherein the delivery vehicle is configured for automated navigation.

17. A method of transferring material items from a delivery vehicle to a receptacle enclosure apparatus comprising:
positioning a delivery vehicle near a receptacle enclosure apparatus for unloading a material item or items;
said receptacle enclosure apparatus comprising:
an outer housing wherein there is at least one opening;
wherein at least one opening is configured to permit delivery items moving inside of the enclosure without manual contact;
unloading said material item from said delivery vehicle to said receptacle enclosure apparatus by any mechanical means without manual contact.

18. The method of claim 17, wherein the delivery vehicle is positioned and the material item unloaded under the authority of at least one computer control circuit.

19. The method of claim 17, wherein the receptacle enclosure is a parked motor vehicle that opens to receive a material item from the vehicle.

20. The method of claim 17, wherein the delivery vehicle is configured for aerial transportation.
